(19) United States
(12) Patent Application Publication
(10) Pub. No.: US 2007/0058096 A1
(43) Pub. Date: Mar. 15, 2007

(54) Storage capacitor structure for liquid crystal display

(75) Inventors: Che-Fu Tsai, Chiayi County (TW); Yi-Lin Chou, Taichung County (TW); Wen-Chun Wang, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/223,112

(22) Filed: Sep. 12, 2005

(51) Int. Cl. G02F 1/1343

(52) U.S. Cl. 349/38

(57) ABSTRACT

The present invention is a storage capacitor structure for liquid crystal display panels, by using a portion of the pixel electrode formed by the transparent metal layer that is overlapped and corresponding to the common electrode of the second metal layer, which is used as the storage capacitor for the pixel. The common electrode is also used as the second metal layer of the pixel, which shields unnecessary light of the backlight module to raise the contrast ratio of the whole display panel.

### FIELD OF THE INVENTION

The present invention relates to a storage capacitor structure for liquid crystal display, especially for an active matrix type liquid crystal display, which is used to raise the aperture ratio of a pixel and increase the display luminance of the whole panel.

### BACKGROUND OF THE INVENTION

Liquid crystal displays (LCD) have merits of low radiation, light, thin, short, and small in size, so gradually they are widely used. Because of the characteristics of contrast ratios and view angles, thin film transistor LCDs (TFT LCD) still are main-fashion displays in the market. The light source of TFT LCD is almost from the backlight source. The backlight source passes through several layers of the TFT LCD such as polarizer, color filter, etc. The luminance is only 10% of the original light source. Due to the insufficient luminance, raising the aperture ratio of the panel can improve the displayed luminance of the panel. Nowadays, how to raise the aperture ratio of a pixel on the display panel is still the goal for R&D engineers to achieve.

Please refer to FIG. 1, which is a schematic diagram for the matrix structure of traditional TFT LCD with active device. The LCD panel 10 is composed of the active device TFT 2 that arranges in matrix type, and the storage capacitor 1 is connected to the source electrode (pixel electrode) of the TFT 2. The storage capacitor 1 is composed of the liquid crystal capacitor 1a that is formed by the overlap of the pixel electrode and the common electrode 4 with the liquid crystal layer between them, and the storage capacitor 1b that is parallel to the liquid crystal capacitor 1a. The other side of the liquid crystal capacitor 1a and the storage capacitor 1b connect to the common electrode 4 that is located in the corresponding substrate. The scan line 3 connects to the gate electrode of the TFT 2, and the data line 5 connects to the drain electrode of the TFT 2. By way of the signal supplied by the scan line 3, the TFT 2 is controlled in an ON or OFF state. When the TFT 2 is ON, the image-signal voltage is supplied to the source electrode (pixel electrode) of the TFT 2 through the data line 5. The voltage level of storage capacitor 1 is charged to almost the same voltage level with the drain electrode of the TFT 2. There are the scan connecting pad 8 of the scan line 3 and the data connecting pad 9 of the data line 5 connecting to the driver IC.

Besides, the liquid crystal display panel has the electrostatic discharge protecting circuit 7 that is located between the scan line 3 and the common node 6, and between the data line 5 and common node 6. When electrostatic discharge voltage is generated, the ESD (Electrostatic Discharge) energy can be discharged through the electrostatic discharge protecting circuit 7. As a result, the TFT 2 can avoid being broken. The electrostatic discharge is generated during the manufacturing process of liquid crystal display devices, especially the manufacturing process of bonding the driver IC.

Please refer to FIG. 2, which is a schematic diagram for a pixel layout structure. The pixel structure includes the TFT 11, the light shielding bar 13, the scan line 14 formed by the first metal layer, the active area 15, the data line 16 formed by the second metal layer, the pixel electrode 17, and the common electrode 18. The storage capacitor is made by using the overlap area 19 that is between the common electrode 18 formed by the first metal layer and the source electrode (pixel electrode) of the TFT 11 formed by the second metal layer. Besides, the light shielding bar 13 is used to be shielded unnecessary light from the backlight module and raise the contrast ratio. Accordingly, the design of pixel structure can achieve charge storage and shielding light at the same time. However, the aperture ratio resulted from this method will not be enough if the area is fixed because the area of the overlap area 19 for constructing the storage capacitor will occupy some area of pixel, and the light shielding bar 13 also occupies a certain area. Under the trend of high resolution (small pixel) for display panels, this design method is not useful for the high aperture ratio.

In accordance with the afore-mentioned defects, U.S. Pat. No. 6,262,784 proposed a structure of storage capacitor that is established by the overlap area between the common electrode formed by the first metal layer and the transparent metal layer, the pixel electrode (ex: ITO). Although this method has the higher aperture ratio than the traditional pixel layout structure, there are two insulating layers between the common electrode and the pixel electrode due to the manufacturing process of TFT components. The first insulating layer is the gate insulating layer, and the second insulating layer is the passivation layer. Knowing from the formula for parallel-plate capacitors, the capacitance between two parallel plates is inversely proportional to the thickness between them. Therefore, because it is not easy to change original TFT processes, how to reduce the thicknesses of the insulating layers is hard to achieve.

### SUMMARY OF THE INVENTION

Consequently, for improving the above-mentioned problems, the main purpose of the current invention is the storage capacitor structure for liquid crystal displays. The corresponding overlap area between the common electrode formed by the second metal layer and the pixel electrode formed by the transparent metal layer with the second insulating layer between them form the storage capacitor structure for the pixel to storage charge. Because the thickness of the second insulating layer is thinner than prior pixel structure (U.S. Pat. No. 6,262,784) in the storage capacitor structure and the single thickness is easier to modify than prior technology. A necessary storage capacitance with the current invention is obtained by using less overlapped area than the well-known method. By way of this, the current invention promotes the aperture ratio of a pixel and increases the displayed luminance of the whole panel.

The second purpose of the current invention is that the common electrode can be the light shielding bar for the pixel. The common electrode can avoid unnecessary lights of the backlight module when the common electrode and the pixel electrode form the storage capacitor so that the contrast ratio of the whole display panel can be raised.

The present invention is a storage capacitor structure for liquid crystal displays, which includes a substrate, a first metal layer that covers the substrate, a first insulating layer that covers the first metal layer, a second metal layer that covers the first insulating layer, a second insulating layer that covers the second metal layer, and a pixel electrode that covers the second insulating layer. A portion of the pixel electrode is corresponding to the second metal layer. By using the corresponding overlap area with the second insulating layer between them forms the storage capacitor structure.

To sum up above-mentioned, the current invention includes the common electrode which is formed by the second metal layer and the storage capacitor structure is formed with the second insulating layer between common electrode and pixel electrode. At the same time the second metal layer of common electrode can be the light shielding bar for the pixel to shield unnecessary lights of the backlight module and raise the contrast ratio.

### BRIEF DESCRIPTION FOR THE DRAWINGS

FIG. 1 is a schematic diagram for the structure of a traditional TFT LCD pixel.

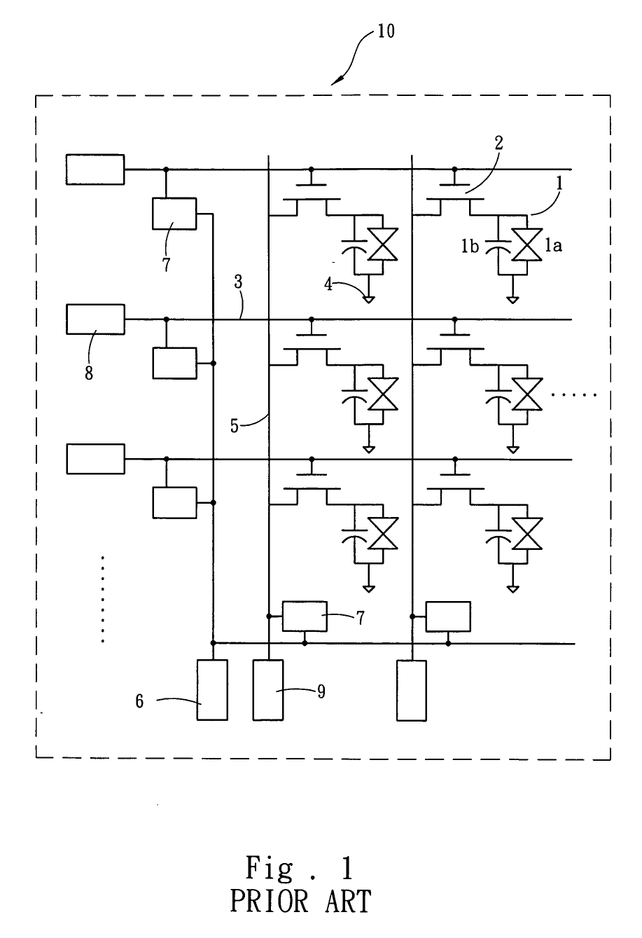

FIG. 2 is a schematic diagram for the structure of a well-known TFT LCD pixel.

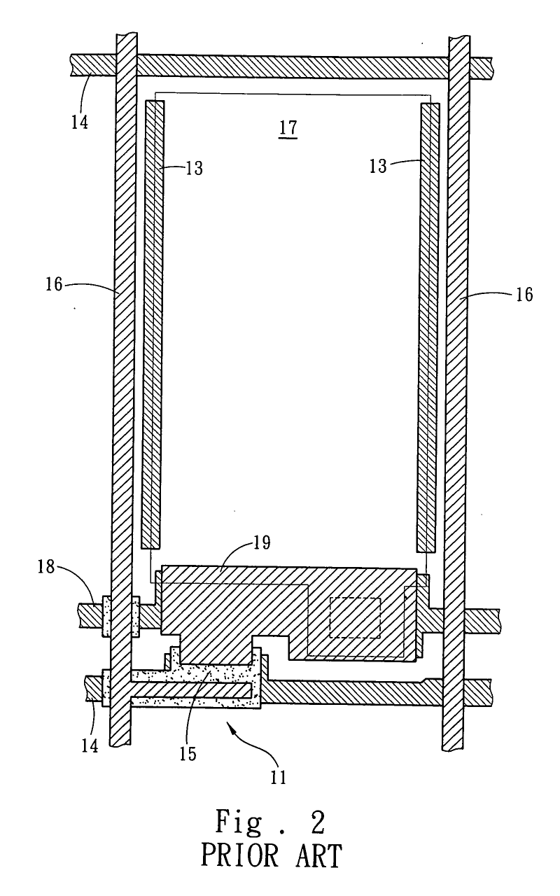

FIG. 3 is a schematic diagram for the structure of a TFT.

FIG. 4A is a schematic diagram for the pixel structure of the first embodiment of the present invention.

FIG. 4B is a 4B-4B cross-sectional diagram for FIG. 4A.

FIG. 5 is a schematic diagram for the pixel structure of the second embodiment of the present invention.

### DETAILED DESCRIPTION OF THE PREFERRED EMBODIMENTS

The detailed descriptions for content and technology of this invention associate with figures are as follows.

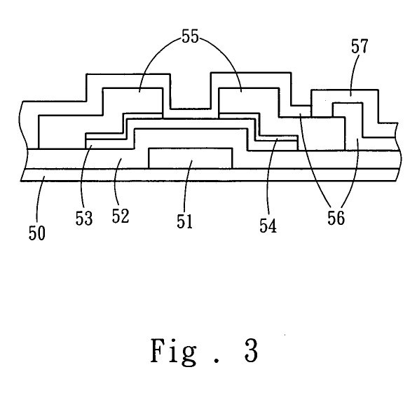

Please refer to FIG. 3, which is the cross-sectional diagram for the structure of a TFT in the normal TFT process. First, the first metal layer forms the gate electrode 51 of the TFT structure and the scan line of a pixel on the surface of the substrate 50. The first metal layer forming for the materials is done by sputtering equipments. The materials are the group of Mo, Ta, Cr, W, Al, and aluminum alloy or arbitrary combinations of them. They can also be used to produce the multilayer as required. Second, the first insulating layer forms the gate insulating layer 52 and the semiconductor layer where the filming method for the semiconductor layer is done by PECVD equipments continuously on the gate insulating layer 52 (ex: SiNx), the a-Si:H intrinsic layer 53, and the n+Si Ohmic Contact film 54. The filming method for the a-Si:H intrinsic layer 53 and the SiNx gate insulating layer 52 are continuous. Hence this method can get a better interface of the SiNx and the a-Si:H semiconductor film. The next step is to form the pattern of the active layer of TFT by way of the photolithography and the etching module. Then, the second metal layer is formed by the sputtering process and the pattern 55 is formed the drain and source electrodes of the TFT structure by photolithography. After that, using the dry etching method etches the n+Si. Ohmic Contact film 54 at the back channel of TFT. Next, using the thin-film manufacturing process deposits the second insulating layer 56 by the CVD so as to form the passivation. The photolithography then follows to dig holes at connections between the source electrode of TFT and pixel electrode layers. Then, the pixel electrode 57 is formed by the transparent metal layer by sputtering, such as indium tin oxide (ITO).

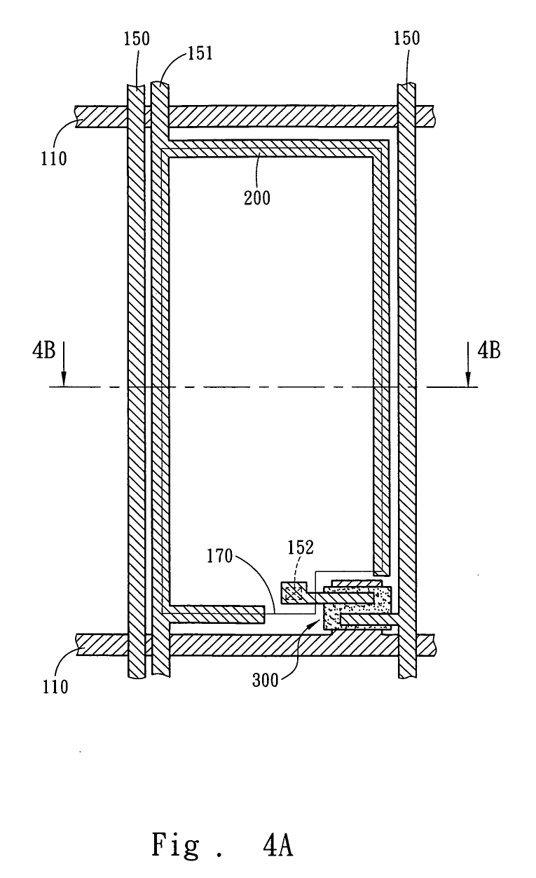

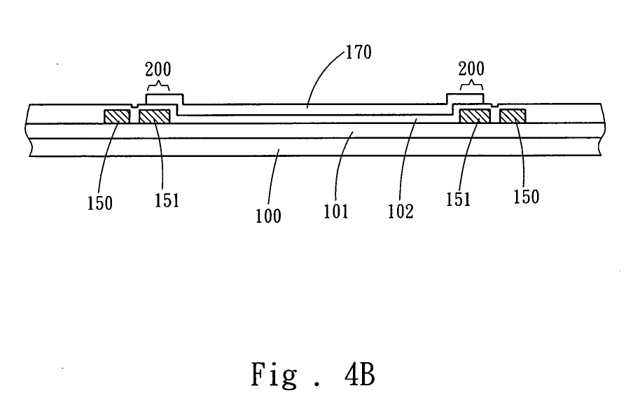

After describing the normal structure of the TFT, please refer to FIGS. 4A and 4B, which show the first embodiment of the pixel structure of this invention. This invention includes the substrate 100; the first metal layer that covers the substrate 100, and the first metal layer is the scan line 110 of the LCD panel; the first insulating layer 101 that covers the first metal layer; the second metal layer that covers the semiconductor layers, and the second metal layer is the data line 150 and the common electrode 151 of the TFT LCD panel; the second insulating layer 102 that covers the second metal layer; the pixel electrode 170 formed by the transparent metal layer that covers the second insulating layer 102, and a portion of the pixel electrode 170 is corresponding to the common electrode 151 of the second metal layer such that the pixel electrode and the common electrode 151 with the second insulating layer 102 between them form the corresponding overlap area 200; and the overlap area 200 is the storage capacitor of TFT pixel structure.

The storage capacitor structure in this invention is constructed by using the corresponding overlap area 200 between the common electrode 151 formed by the second metal layer and the pixel electrode 170 formed by the transparent metal layer. The first embodiment includes the TFT 300; the scan line 110 formed by the first metal layer and patterned on the surface of the substrate 100, wherein the scan line 110 of the pixel presents a horizontal line that is formed by the first metal layer, the data line 150 formed by the second metal layer presents a vertical line, and the common electrode 151 constructed cross the scan line 110 of the pixel is formed by the second metal. And then deposit the second insulating layer 102 so as to form the passivation, the contact pad 152, and the pixel electrode 170 formed by the transparent metal layer (wherein the contact pad 152 is used to connect the source electrode of the TFT 300 and the pixel electrode 170). The overlap area 200 of the common electrode 151 and the pixel electrode 170 with second insulating layer 102 between them formed storage capacitor of TFT pixel to hold charge.

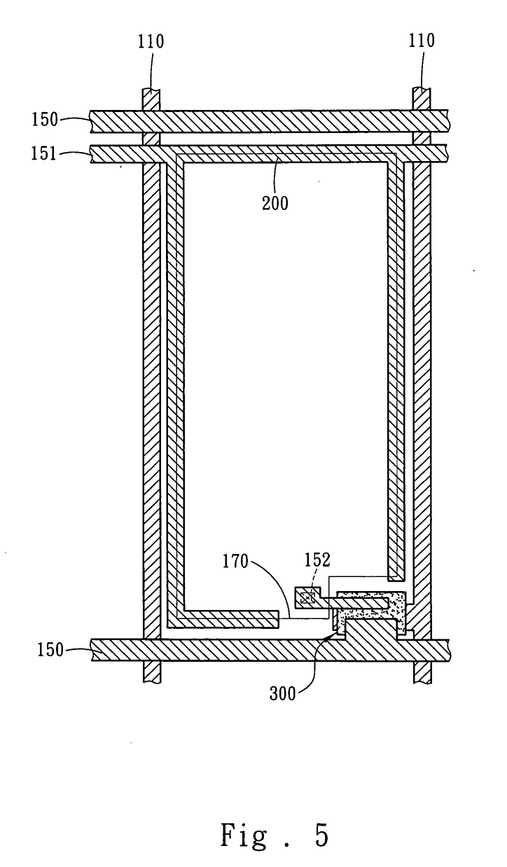

Please refer to FIG. 5, which shows the second embodiment of the pixel structure in this invention. Similarly, the second embodiment is based on the same spirit of this invention, and the structure of the storage capacitor is constructed by using the corresponding overlap area 200 between the common electrode 151 formed by the second metal layer and the pixel electrode 170 formed by the transparent metal layer. The differences between the first and second embodiments are that the scan line 110 formed by the first conductive-metal layer is changed to the vertical line, and the data line 150 formed by the second metal layer is changed to the horizontal line. The second embodiment includes the TFT 300; the scan lines 110 that are patterned on the surface of the substrate 100 in which the scan lines 110 presented as the vertical line are formed by the first metal layer; the data line 150 formed by the second metal layer and presenting a horizontal line; and the common electrode 151 constructed cross the scan line 110 of the pixel. And then deposit the second insulating layer 102 so as to form the passivation, the contact pad 152, and the pixel electrode 170 formed by the transparent metal layer (wherein the contact pad 152 is used to connect the source electrode of the TFT 300 and the pixel electrode 170). The overlap area 200 of the common electrode 151 and the pixel electrode 170 with second insulating layer 102 between them formed storage capacitor of TFT pixel to hold charge.

Besides, at the same time when the storage capacitor structure is constructed by using the corresponding overlap area 200 between the common electrode 151 formed by the second metal layer and a portion of the pixel electrode 170 can be the light shielding bar for the pixel to shield unnecessary lights of the backlight module and raise the contrast ratio. The current invention is unlike the traditional method, so it is not necessary to design the masking layer to increase the aperture ratio.

However, the above description is only a better practice example for the current invention, which is not used to limit the practice scope of the invention. All equivalent changes and modifications based on the claimed items of this invention are in the scope of the present invention.

What is claimed is:

1. A storage capacitor structure for liquid crystal display panel, the storage capacitor structure comprising:
a substrate;
a first metal layer deposed on the substrate;
a first insulating layer deposed on the first metal layer;
a second metal layer deposed on the first insulating layer;
a second insulating layer deposed on the second metal layer; and
a pixel electrode deposed on the second insulating layer, wherein a portion of the pixel electrode overlaps the second metal layer to form the storage capacitor of liquid crystal display panel.

2. The storage capacitor structure as claimed in claim 1, wherein the first metal layer is a scan line of the LCD panel.

3. The storage capacitor structure as claimed in claim 1, wherein the second metal layer includes a data line and a common electrode of the LCD panel.

4. The storage capacitor structure as claimed in claim 3, wherein a portion of the pixel electrode overlaps the common electrode to form the storage capacitor of liquid crystal display panel.
